(19) United States
(12) Patent Application Publication
(10) Pub. No.: US 2006/0179291 A1
(43) Pub. Date: Aug. 10, 2006

(54) Multithread processor and method for operating a multithread processor

(75) Inventor: Lorenzo Di Gregorio, Pescara (IT)

Correspondence Address: Maginot, Moore & Beck;Chase Tower, Suite 3250, 111 Monument Circle, Indianapolis, IN, 46204, US

(73) Assignee: Infineon Technologies AG, Munchen (DE)

(21) Appl. No.: 11/327,301

(22) Filed: Jan. 6, 2006

(30) Foreign Application Priority Data
Jan. 7, 2005 (DE) 10 2005 001 025.3

(51) Int. Cl. G06F 9/44

(52) U.S. Cl. 712/228

(57) ABSTRACT

A multithread processor for the data processing of a plurality of threads, each being provided with a dedicated context, comprises a switching table. The switching table receives at least one of an internal exception of a specific context for updating the specific context and for switching from the specific context to a target context of the internal exception or an external exception of a specific context for updating the specific context and for switching from the specific context to a target context of the external exception, and, in a manner dependent thereon, updates at least one of a context parameter set of the context, a context parameter set of the target context of the internal exception, or a context parameter set of the target context of the external exception, and sets a switch parameter set for a sequence control of program instructions to be fetched, so that the multithread processor switches between the context and the target context of at least one of the internal or the external exception without restrictions or cycle loss.

### BACKGROUND OF THE INVENTION

1. Field of the invention

The invention relates to a multithread processor and a method for operating a multithread processor.

2. Description of the Related Art

### SUMMARY OF THE INVENTION

Embedded processors and their architectures are measured by their power consumption, their throughput, their utilization, their costs and their real time capability. In order to increase in particular the throughput and the utilization, the principle of multithreading is used. The basic idea of multithreading is based on a processor processing a plurality of threads. In particular, this exploits the fact that during a latency of one thread, program instructions of the other thread can be processed. In this case, a thread denotes a control path of a code or source code or program, data dependencies existing within a thread and weak data dependencies existing between different threads (as in chapter 3 in T. Beierlein, O. Hagenbruch: “Taschenbuch Mikroprozessortechnik” [“Guide to Microprocessor Technology”], 2nd Edition, Fachbuchverlag Leipzig im Karl Hanser-Verlag Munich-Vienna, ISBN 3-446-21686-3). A context of a thread is the execution state of the program instruction sequence of the thread. Accordingly, the context of a thread is defined as a temporary processor state during the processing of the thread by this processor. The context is held by the hardware of the processor, conventionally the program counting register or program counter, the register file or context memory and the associated status register. A restriction is understood to mean for example a restriction of the selection of the thread to which the processor can switch during a changeover, or a restriction of the changeover instant.

By way of example, Ungerer, Theo et al. (2003) “Survey of Processors With Explicit Multithreading” in ACM Computing Surveys, Volume 35, March 2003, describes a comprehensive listing of the known multithread processors and architectures.

It is disadvantageous that the thread switch in the case of the multithread processors and architectures described is effected non-deterministically, that is to say that the number of context switches is not known to the programmer, but rather is dependent on all the input data, which have to be considered as random variables. Consequently, particularly for embedded processors, in which the real time capability is of outstanding importance, it is necessary to be able to cope with a cycle loss during the switch by providing enough clock cycles so that even the worst case, that is to say the maximum possible number of context switches, is taken into account. By virtue of the maximum number of context switches being taken into account in this way, the costs, that is to say the clock cycles of the multithread processor that have to be provided for the thread switch are increased unnecessarily because the performance of the processor in certain special cases, in particular in the worst case, turns out to be significantly lower than the performance in normal operation.

In order to elucidate the problem area on which the invention is based, FIG. 1 illustrates a schematic flow diagram of a processing of two threads T1, T2 by a multithread processor MT. The first thread T1 and the second thread T2 can in each case be executed in the regions drawn in hatched fashion. The regions of the first thread T1 and of the second thread T2 which are identified by St are so-called stalls ST, and no program instructions of the first thread T1 or of the second thread T2 can be executed during said stalls. The third line of FIG. 1 illustrates how the multithread processor MT alternately processes the first thread T1 and the second thread T2 in temporal succession (see time scale t) in such a way that the stalls St do not have an effect. In order, however, to switch between the first thread T1 and the second thread T2, and vice versa, a cycle loss (switch overhead) SO requiring two clock cycles, for example, is necessary in each case. It is disadvantageous that in each case in these two clock cycles the multithread processor MT cannot process any program instructions. If the number of switch events of an application is uncertain, then the application has to be dimensioned for the maximum number (worst case). Such a maximum number is often significantly higher than the number of switching events that arises for the majority of cases. As a result, the application disadvantageously has to be significantly overdimensioned only to cope with extremely few and extremely infrequent cases.

### SUMMARY OF THE INVENTION

It is an object of the present invention to provide a deterministic context switching in a multithread processor without cycle loss.

The object is achieved in accordance with the invention by means of a multithread processor with a context switch without restrictions and/or cycle losses for the data processing of a plurality of threads, a dedicated context being provided for each thread within the multithread processor, the inventive multithread processor having a switch table, which receives an internal exception of a specific context for updating this context and for switching from this context to a target context of the internal exception and/or an external exception of a specific context for updating this context and for switching from the this context to a target context of the external exception and, in a manner dependent thereon, updates a context parameter set of this context and/or a context parameter set of a target context of the internal exception and/or a context parameter set of a target context of the external exception, and sets a switch parameter set for a sequence control of the program instructions to be fetched, in such a way so that the multithread processor switches without restrictions and/or cycle loss between the context and the target context of the internal exception and/or the target context of the external exception.

In this case, a switching is advantageously effected in such a way that the threads still remain “coherent”. In this context coherent means that a thread implements the same function independently of the order with which different instructions of different threads are executed.

For the definition of exception, reference is made to chapter 3.3.6 in T. Beierlein, O. Hagenbruch: “Taschenbuch Mikroprozessortechnik”, 2nd Edition, Fachbuchverlag Leipzig im Karl Hanser-Verlag Munich-Vienna, ISBN 3-446-21686-3, which is herein incorporated by reference.

The object is also achieved in accordance with the invention by means of a method for operating the multithread processor with a context switch without restrictions and/or cycle loss for the data processing of threads, a dedicated context being provided for each thread within the multithread processor, the method according to the invention having the following method steps of:

receiving an internal exception of a specific context for updating this context and switching from this context to a target context of the internal exception and/or an external exception of a specific context for updating this context and switching from this context to a target context of the external exception; and

updating a context parameter set of the current context and/or a context parameter set of a target context of the internal exception and/or a context parameter set of the external exception and setting a switching parameter set for a sequence control of the program instructions to be fetched in such a way that the multithread processor switches without restrictions and/or cycle loss between the current context and the target context of the internal exception and/or the target context of the external exception.

The updating of any context parameter sets of all the contexts referenced by the internal and external exceptions and of the current context in a manner dependent on the also possibly competing exceptions advantageously makes it possible to switch from the current context to a target context and also to switch back from this target context to one of the other two contexts without any additional restrictions and/or cycle loss. The continuous updating of the context parameter sets present enables a switching always to be effected without any additional restriction and/or cycle loss. Consequently, the context switch for the architecture according to the invention is deterministic because an uncertain number of switchings requires a specific number of clock cycles, to be precise zero. As a result, whereby the performance and the throughput of the multithread processor inherently increase and the need to dimension the application for the highest number of switchings (worst case) disappears.

In a restricted version of the inventive processor or method, an instruction fetching pipeline stage for fetching program instructions from a program instruction memory and an instruction decoding pipeline stage are provided, the switch table being arranged in the instruction decoding pipeline stage.

The switching parameter set may be formed from at least one of the following parameters:
context flag, which specifies the current context of the corresponding pipeline stage;
program instruction address of a next program instruction of the current context of the corresponding pipeline stage;
squash reset flag, which specifies processing again subsequent program instructions of the current context of the corresponding pipeline stage;
kill flag, which indicates not taking account of jump instructions of a subsequent pipeline stage which are situated in the current context of the changeover table.

Each context parameter set may be formed from at least one of the following parameters:
program address of the corresponding context;
program address of a delay slot instruction of the corresponding context;
squash flag of the corresponding context, which specifies not processing program instructions of the corresponding context;
flag for specifying a pending program address of the corresponding context;
flag for specifying a pending delay slot instruction of the corresponding context;
flag for specifying a number of pending delay slot instructions of the corresponding context.

Delay slot instructions are program instructions which follow a jump instruction of the same context, but are still always executed despite the jump instruction.

In a further restricted version of the inventive processor or method, the switch table, upon receiving the internal exception and the external exception, updates the context parameter set of the current context, the context parameter set of the target context of the internal exception and the context parameter set of the target context of the external exception in such a way that the multithread processor switches from the current context to the target context of the external exception, upon occurrence of a blocking of the target context of the external exception to the target context of the internal exception and then, upon occurrence of a blocking of the target context of the internal exception, back to the original current context.

The instruction decoding pipeline stage may have a program address table, which buffer-stores the valid context parameter set in each case for each context of the multithread processor, the switch table in each case updating the stored context parameter sets of the current context, of the target context, of the internal exception and of the target context of the external exception.

At least one further pipeline stage may be provided which is arranged downstream of the instruction decoding pipeline stage and which processes the decoded program instructions further.

Each further pipeline stage, if the program instruction that it processes is a jump instruction, may provide a further switch parameter set and a validity signal for specifying a validity of the further switch parameter set.

In a further restricted version of the inventive processor or method, a sequence control is provided, which receives the switch parameter set of the instruction decoding pipeline stage and also the further switch parameter sets and validity signals of the further pipeline stages arranged downstream and, in a manner dependent thereon, generates a context parameter specifying which context is processed next, a program address of the next context to be processed, and the squash reset flag of the next context to be processed and transmits them to the instruction fetching pipeline stage.

The instruction etching pipeline stage may fetch the next program instruction from the program instruction memory in a manner dependent on the context parameter received by the sequence control and the received associated program address.

A buffer memory may be provided, which provides, for each context of the multithread processor, a sub buffer memory in which at least in each case program instructions, in particular delay slot instructions of the corresponding context can be buffer-stored.

The switch table may address, by means of a memory flag, the respective sub buffer memory for a buffer-storage of program instructions with the corresponding context parameter and the corresponding squash reset flag of the corresponding context.

The instruction decoding pipeline stage may have an instruction decoder for decoding the fetched program instructions.

In a further restricted version of the inventive method or processor, the instruction decoder receives the context parameter, a program instruction addressed by the program address and fetched from the program instruction memory, and the squash reset flag from the buffer memory and also the flag for specifying the number of delay slot instructions of the context to be processed from the program address table, and, in a manner dependent thereon, updates the flag for specifying the number of delay slot instructions, the address of the delay slot instruction of the context to be processed and the address of the pending delay slot instruction of the context to be processed and transmits them to the program address table.

In a further restricted version of the inventive processor or method, the instruction decoder, in each clock cycle, reads out a program instruction of the current context and the associated squash reset flag from the buffer memory and sets the squash flag of the current context to a negative logic signal level if the read-out squash reset flag has a positive logic signal level.

In another restricted version of the inventive processor or method, the instruction decoder, in each clock cycle in which the squash flag of the current context is set to a positive logic signal level, writes NOP instructions to the respective sub buffer memory for the current context of the buffer memory.

In a further restricted version of the inventive processor or method, the instruction decoder, in the case of a positive signal level of the flag for specifying the number of delay slot instructions of the current context, sets the next program address to the address of the delay slot instruction of the current context if the flag for specifying a pending delay slot instruction of the current context has a positive signal level.

The instruction decoder in the case of a positive signal level of the flag for specifying the number of delay slot instructions of the current context and a negative signal level of the flag for specifying a pending program address of the current context, may set the next program address to the program address of the current context if the flag for specifying a pending program address has a positive signal level.

The instruction decoder, in the case of a positive signal level of the flag for specifying the number of delay slot instructions of the current context, a negative signal level of the flag for specifying a pending program address of the current context and a negative signal level of the flag for specifying a pending program address of the current context, may set the next program address to the program address of the current context incremented by one.

In a further restricted version of the inventive processor or method, the sequence control receives the switch parameter set of the instruction decoding pipeline stage and also the further changeover parameter sets and the validity signals of the further pipeline stages and, in a manner dependent thereon, in each case determines the lowest pipeline stage of the pipeline for each context of the multithread processor which processes a jump instruction of the respective context.

The sequence control, in a manner dependent on the determined lowest pipeline stage of the current context flag, may determine the context parameter of the next context to be processed, the program address of the next context to be processed and the squash reset flag of the next context to be processed.

The sequence control, for each context of the multithread processor which does not correspond to the current context flag, in each case may update the corresponding context parameter set and writes the updated context parameter sets to the program address table.

In a further restricted version of the inventive processor or method, a selection device is provided, which receives the context parameter set of the current context, the context parameter set of the target context of the internal exception and the context parameter set of the target context of the external exception from the changeover table, the context parameter set of the current context from the program address table and the next program address from the instruction decoder and, in a manner dependent thereon, generates the next program instruction address and the associated squash reset flag of the current context and transmits them to the sequence control.

Each pipeline stage which is arranged downstream of the instruction decoding pipeline stage may provide an internal exception upon occurrence of an interrupt.

### DESCRIPTION OF THE DRAWINGS

FIG. 1 as discussed above, is a schematic flow diagram of a processing of two threads by a multithread processor for elucidating the problem area on which the invention is based;

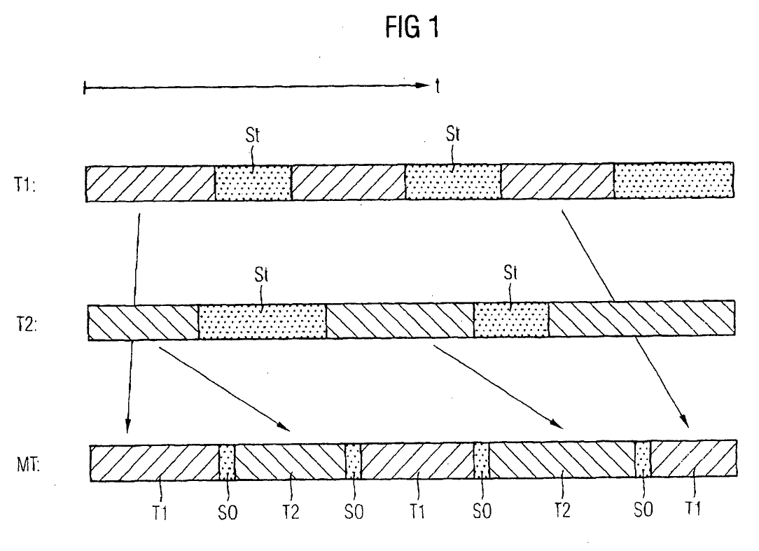

FIG. 2 is a schematic block diagram of a preferred exemplary embodiment of the inventive multithread processor according;

FIG. 3 is a schematic illustration of a particularly preferred embodiment of the switch table of the inventive multithread processor; and

FIG. 4 is a schematic flow diagram illustrating a preferred exemplary embodiment of the inventive method.

### DESCRIPTION OF THE PREFERRED EMBODIMENTS

In all the figures, identical or functionally identical elements and signals—unless specified otherwise—have been provided with the same reference symbols.

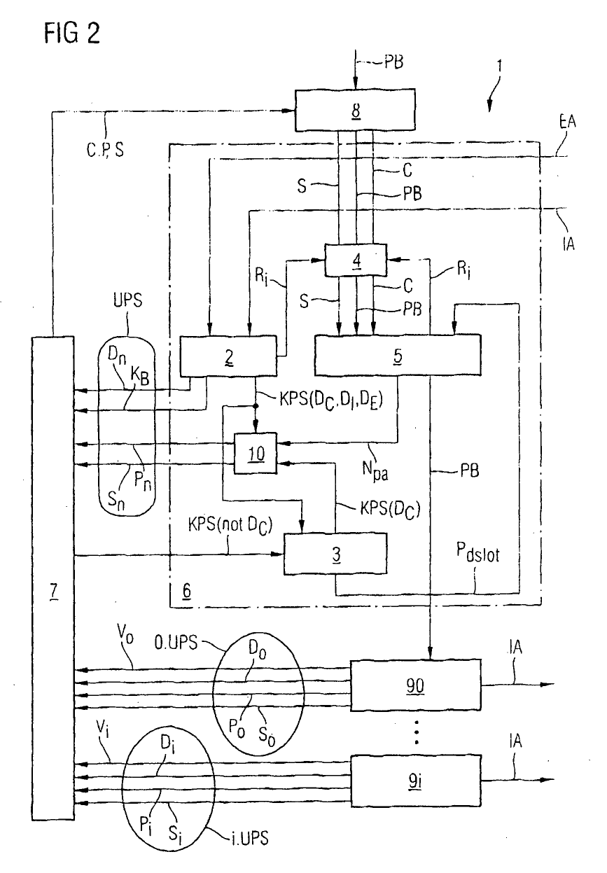

FIG. 2 shows a schematic block diagram of a preferred exemplary embodiment of the multithread processor 1 according to the invention. The multithread processor 1 according to the invention processes program instructions PB of a plurality of threads, a dedicated context being provided for each thread within the multithread processor 1. In this case, the current context D_{C} that is processed by the instruction decoder 5 is designated by D_{C}, a first target context is designated by D_{I}, D_{E} and a second target context is designated by D_{I}, D_{E}.

The multithread processor 1 according to the invention has a switch table 2. The switch table 2 receives internal exceptions IA for switching over from a current context D_{C} to a target context D_{I}, D_{E} of the internal exception IA and/or an external exception EA for changing over from a current context D_{C} to a target context D_{I}, D_{E} of the external exception EA within a clock cycle. The internal exceptions IA correspond in particular to internal interrupts that are provided by downstream pipeline stages 90, 9i. The external exceptions EA correspond to external instructions that are provided in particular by the programmer.

Depending on the received internal exception IA and/or the received external exception EA, the switch table 2 updates a context parameter set KPS(D_{C}) of the current context D_{C} and/or a context parameter set KPS(D_{I}) of a target context D_{I}, D_{E} of the internal exception EA and/or a context parameter set KPS(D_{E}) of a target context (D_{E}) of the external exception EA and a switch parameter set UPS for a sequence control 7 of the program instructions PB to be fetched in such a way that the multithread processor 1 switches without restrictions and/or cycle loss between the current context D_{C} and the target context D_{I}, D_{E} of the internal exception IA and/or the target context D_{I}, D_{E} of the external exception EA.

Preferably, the multithread processor 1 according to the invention has an instruction fetching pipeline stage 8 for fetching program instructions PB from the program instruction memory (not shown) and an instruction decoding pipeline stage 6, the changeover table 2 being arranged in the instruction decoding pipeline stage 6. Furthermore, the multithread processor 1 according to the invention preferably has at least one further pipeline stage 90, 9i which is arranged downstream of the instruction decoding pipeline stage 6 and which processes the decoded program instructions PB further.

Preferably, each further pipeline stage 90, 9i provides a further switch parameter set 0.UPS, i.UPS and a validity signal V₀, Vᵢ for specifying a validity of the further changeover parameter set 0.UPS, i.UPS if the program instruction PB that it processes is a jump instruction.

Preferably, the switch parameter set UPS that is provided to the sequence control 7 by the instruction decoding pipeline stage 6 has the following parameters:
a context flag Dₙ, which specifies the current context of the instruction decoding pipeline stage 6;
a program instruction address Pₙ of a next program instruction PB of the current context of the instruction decoding pipeline stage 6;
a squash reset flag Sₙ, which specifies processing again subsequent program instructions PB of the current context of the instruction decoding pipeline stage 6; and
a kill flag K_{B}, which indicates not taking account of jump instructions of a subsequent pipeline stage 90, 9i which are situated in the current context of the changeover table 2.

Preferably, the further switch parameter sets 0.UPS, i.UPS that are provided to the sequence control 7 by the further pipeline stages 90, 90i have the following parameters:
a context flag Dᵢ, which specifies the current context of the corresponding pipeline stage 9i;
a program instruction address Pₙ of a next program instruction PB of the current context of the corresponding pipeline stage 9i;
a squash reset flag Sₙ, which specifies processing again subsequent program instructions PB of the current context of the corresponding pipeline stage 9i.

An analogous situation with the index i=O holds true for the pipeline stage 90 that is arranged directly downstream of the instruction decoding pipeline stage 6.

Preferably, each context parameter set KPS(D_{C}), KPS(D_{I}), DPS(D_{E}), which is updated by the switch table 2 in each clock cycle, is formed from at least one of the following parameters:
program address Pₚₐ of the corresponding context D_{C}, D_{I}, D_{E};
program address P_{da} of a delay slot instruction of the corresponding context D_{C}, D_{I}, D_{E};
flag Pₚₐ_{_{—}}_{pending} for specifying a pending program address of the corresponding context;
flag P_{da}_{_{—pending}} for specifying a pending delay slot instruction of the corresponding context D_{C}, D_{I}, DE;
flag P_{dslot} for specifying a number of pending delay slot instructions of the corresponding context D_{C}, D_{I}, D_{E}.

Furthermore, the multithread processor 1 according to the invention has, within the instruction decoding pipeline stage 6, a program address table 3, which buffer-stores the valid context parameter set KPS(D_{C}), KPS(D_{I}), KPS(D_{E}) in each case for each context (D_{C}, D_{I}, D_{E}) of the multithread processor 1, the switch table 2 in each case updating the stored context parameter sets KPS(D_{C}), KPS(D_{I}), KPS(D_{E}) of the current context D_{C} of the target context D_{I} of the internal exception IA and of the target context D_{E} of the external exception EA and writing them to the program address table 3.

Furthermore, the multithread processor 1 according to the invention has a sequence control 7, which receives the switch parameter set UPS of the instruction decoding pipeline stage 6 and also the further changeover parameter sets 0.UPS,i.UPS and validity signals V₀, V_{I} of the further pipeline stages 90, 9i arranged downstream and, in a manner dependent thereon, generates a context parameter C specifying which context D_{C}, D_{I}, D_{E} is processed next, a program address P of the next context D_{C}, D_{I}, D_{E} to be processed, and the squash reset flag S of the next context D_{C}, D_{I}, D_{E} to be processed and transmits them to the instruction fetching pipeline 8.

The instruction fetching pipeline 8 fetches the next program instruction PB from the program instruction memory in a manner dependent on the context parameter C received by the sequence control 7 and the received associated program address P (not shown).

Preferably, the multithread processor 1 according to the invention furthermore has a buffer memory 4, which provides, for each context D_{C}, D_{I}, D_{E} of the multithread processor 1, a sub buffer memory in which at least in each case program instructions PB, in particular delay slot instructions of the corresponding context D_{C}, D_{I}, D_{E} can be buffer-stored.

By way of example, the switch table 2 addresses, the respective sub buffer memory for a buffer-storage of program instructions PB with the corresponding context parameter C and the corresponding squash reset flag S of the corresponding context D_{C}, D_{I}, D_{E}, by means of a memory flag Ri.

Preferably, the instruction decoding pipeline stage 6 has an instruction decoder 5 for decoding the fetched program instructions PB.

Preferably, the instruction decoder 5 receives the context parameter C, a program instruction PB addressed by the program address P and fetched from the program instruction memory, and the squash reset flag S from the buffer memory 4 and also the flag P_{dslot} for specifying the number of delay slot instructions of the context D_{C}, D_{I}, D_{E} to be processed from the program address table 3. In a manner dependent thereon, the instruction decoder 5 updates the flag P_{dslot} for specifying the number of delay slot instructions, the address P_{da} of the delay slot instruction of the context D_{C}, D_{I}, D_{E} to be processed and the address P_{da}_{_{—}}_{pending} of the pending delay slot instruction of the context D_{C}, D_{I}, D_{E} to be processed and transmits them to the program address table 3.

Preferably, the instruction decoder 5, in each clock cycle, reads out a program instruction PB of the current context D_{C} and the associated squash reset flag S from the buffer memory 4 and sets the squash flag P_{squash} of the current context D_{C} to a negative logic signal level if the read-out squash reset flag S has a positive logic signal level. In this case, the instruction decoder 5, in each clock cycle in which the squash flag P_{squash} of the current context D_{C} is set to a positive logic signal level, writes exclusively NOP instructions, addressed by the memory flag Rᵢ, to the respective sub buffer memory for the current context D_{C} of the buffer memory 4. Moreover, the instruction decoder 5, in the case of a positive signal level of the flag P_{dslot} for specifying the number of delay slot instructions of the current context D_{C}, sets the next program address Nₚₐ to the address P_{da} of the delay slot instruction of the current context D_{C} if the flag P_{da}_{_{—}}_{pending} for specifying a pending delay slot instruction of the current context D_{C}, D_{I}, D_{E} has a positive signal level. As an alternative, the instruction decoder 5 in the case of a positive signal level of the flag P_{dslot} for specifying the number of delay slot instructions of the current context D_{C} and a negative signal level of the flag Pₚₐ_{_{—}}_{pending} for specifying a pending program address of the current context D_{C}, sets the next program address Nₚₐ to the program address Pₚₐ of the current context D_{C} if the flag Pₚₐ_{_{—}}_{pending} for specifying a pending program address has a positive signal level.

As a further alternative, the instruction decoder 5, in the case of a positive signal level of the flag P_{dslot} for specifying the number of delay slot instructions of the current context D_{C}, a negative signal level of the flag Pₚₐ_{_{—}}_{pending} for specifying a pending program address of the current context D_{C} and a negative signal level of the flag Pₚₐ_{_{—}}_{pending} for specifying a pending program address of the current context D_{C}, sets the next program address Nₚₐ to the program address Pₚₐ of the current context D_{C} incremented by one.

Moreover, the sequence control 7 receives the changeover parameter set UPS of the instruction decoding pipeline stage 6 and also the further switch parameter sets 0.UPS, i.UPS and the validity signals V₀, Vᵢ of the further pipeline stages 90, 9i and, in a manner dependent thereon, in each case determines the lowest pipeline stage Bᵢ of the pipeline for each context of the multithread processor 1 which processes a jump instruction of the respective context. If the kill flag K_{B} is set to a positive signal level, then the current context flag Dₙ of the instruction decoding pipeline stage 6 is used for the context parameter C and subsequent jump instructions of the same context are left out of consideration.

Consequently, the sequence control 7, in a manner dependent on the determined lowest pipeline stage Bᵢ which processes the context that is referenced by the current context flag Dₙ, determines the context parameter C of the next context to be processed, the program address P of the next context to be processed and the squash reset flag S of the next context to be processed.

Moreover, the sequence control 7, for each context D_{C}, Dᵢ, D_{E} of the multithread processor 1 which does not process the context that is referenced by the current context flag Dₙ, in each case updates the corresponding context parameter set KPS(notD_{C}) and writes the updated context parameter sets KPS(not_{DC}) to the program address table 3.

Moreover, the multithread processor 1 according to the invention has a selection device 10. The selection device 10 receives the context parameter set KPS(D_{C}) of the current context D_{C}, the context parameter set KPS(D_{I}) of the destination context D_{I} of the internal exception IA and the context parameter set KPS(D_{E}) of the destination context D_{E} of the external exception EA from the changeover table 2, the context parameter set KPS(D_{C}) of the current context D_{C} from the program address table 3 and the next program address Nₚₐ from the instruction decoder 5 and, in a manner dependent thereon, generates the next program instruction address Pₙ and the associated squash reset flag Sₙ in accordance with the current context flag Dₙ and transmits them to the sequence control 7.

Each pipeline stage 90, 9i which is arranged downstream of the instruction decoding pipeline stage 6 provides an internal exception IA upon occurrence of an interrupt.

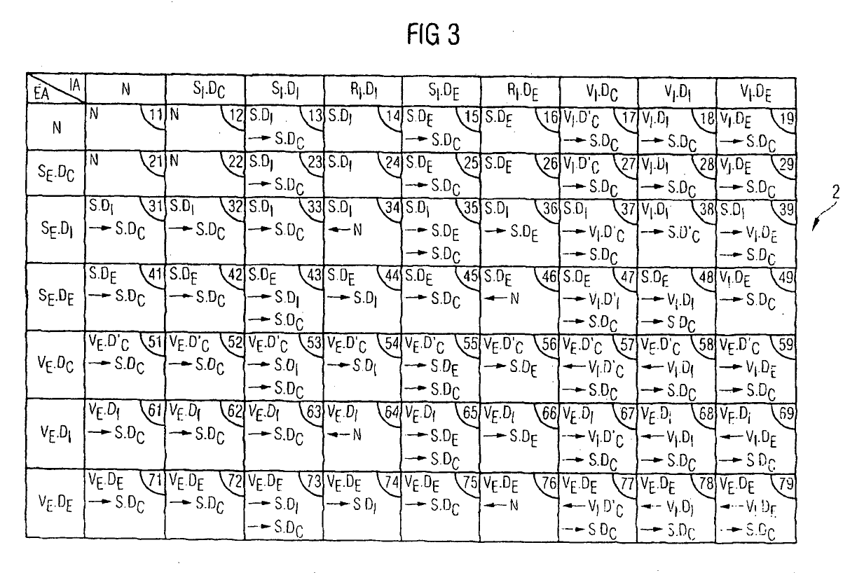

FIG. 3 shows a schematic illustration of a particularly preferred embodiment of the switch table 2 of the multithread processor 1 according to the invention. The switch table 2 receives an internal exception IA for switching a current context D_{C} to a destination context Dᵢ, D_{E} of the internal exception IA and/or an external exception EA for switching from the current context D_{C} to a destination context D_{I}, D_{E} of the external exception EA. In this case, the switch table 2 in accordance with FIG. 3 shows nine different configurations for the internal exception IA in the topmost row. The first column of the switch table 2 shows seven configurations of the external exception EA. One of the matrix elements 11 to 79 of the switch table 2 results depending on the internal exception IA and the external exception EA. Each matrix element 11 to 79 represents an operation or a plurality of operations for updating the corresponding context parameter sets KPS(D_{C}), KPS(D_{I}), KPS(D_{E}). The syntax of the operations of the matrix elements 11 to 79 will be explained after explaining the different inputs for the internal exception IA and the external exception EA.

The different input values of the internal exception IA are illustrated first:

1st column of the switch table 2:

N: normal operation, no exception has occurred.

2nd column of the switch table 2:

S_{I}.D_{C}: normal switch to the current context D_{C}.

3rd column:

S_{I}.D_{I}: normal switch to the first destination context D_{I}.

4th column:

R_{I}.D_{L}: return switch from the current context D_{C} to the first destination context D_{I}.

5th column:

S_{I}.D_{E}: normal switch to the second destination context D_{E}.

6th column:

R_{I}.D_{E}: return switch from the current context D_{C} to the second destination context D_{E}.

7th column:

Vᵢ.D_{c}: directed switch to the current context D_{C}. In this connection, directed means that a jump is made to a predetermined address of the respective context.

8th column:

V_{I}.D_{I}: directed switch to the first destination context D_{I}.

9th column:

V_{I}.D_{E}: directed switch to the second destination context D_{E}.

The first column of the switch table 2 shows the seven input values of the external exception EA. The seven switches or directed switches of the external exception EA correspond to the input values of the internal exception IA apart from the indexing E instead of I. Moreover, the external exception EA does not contain any return switches R since the developer or programmer who generates the external exceptions EA is not afforded the possibility of a return switch R.

The operations of the matrix elements 11 to 79 will be explained below. It should be taken into consideration that the operation or operations of each matrix element 11 to 79 is or are executed in precisely one clock cycle. Since one or more operations are executed in each matrix element 11 to 79, the operations will first be clarified generally by means of the context variables X and y. Particular attention should be given to the fact that in the case of a matrix element, such as e.g. in the case of the matrix element 15, which contains a plurality of operations, the destination of the first operation D_{E} is simultaneously also the source for the second operation (D_{E}→S.D_{C}).

First with regard to the possible individual operations of the matrix elements 11 to 79:

N: Normal Operation

No exception has occurred.

S.X Switch to the Context X

The next program instruction address Pₙ of the context X is calculated as a function of the context parameter set of the corresponding context, provided by the program address table 3, or by the next program address Nₚₐ from the instruction decoder 5. Moreover, the squash reset flag Sₙ of the context X is set.

Dₙ=X

Pₙ=Nₚₐ

Sₙ=true

V_{E}.X: Directed Switch to the Context X

The next program instruction address Pₙ of the context X is provided by the directed switch instruction, and in particular the associated address V_{E}.pa by the external exception EA. In order to take account of the current, the context parameter set KPS(X) is updated in the program address table 3.

Dₙ=X

Pₙ=V_{E}.pa

Sₙ=true

Pₚₐ(X)=V_{E}.pa

Pₚₐ_{_{—}}_{pending}(X)=false

P_{da}_{_{—}}_{pending}(X)=false

P_{dslots}(X)=0

Rᵢ(X)=nop

K_{b}=true

V_{I}.X: Directed Switch to the Context X

The next program instruction address Pₙ of the context X is provided by the switch instruction of the internal exception IA, in particular by the associated address V_{I}.pa. In order to take account of the jump or the switch, the context parameter set KPS(X) is updated for the program address table 3.

Dₙ=X

Pₙ=V_{I}.pa

Sₙ=true

Pₚₐ(X)=V_{I}.pa

Pₚₐ_{_{—}}_{pending}(X)=false

P_{da}_{_{—}}_{pending}(X)=false

P_{dslots}(X)=0

Rᵢ(X)=nop

K_{b}=true

X→V.y: Shifted, Directed Switch from the First Context X to the Second Context y:

The next return switch R of the context X is replaced by the operation “X→S.D_{c}v.y”. This corresponds to a reprogramming of the context parameter set of the context y in the program address table 3 in order to take account of the jump or switch and to set the second context y as the one calling the context X. Consequently, the next return switch R of the first context X involves “jumping back” to the set calling entity, the second context y.

C(X)=y

Pₚₐ(y) V.pa

Pₚₐ_{_{—}}_{ending}(y)=true _{P}_{da}_{_{—}}_{pending}(y)=false

P_{dslots}(y)=0

P_{squash}(y)=false

Rᵢ(y)=nop

One example of a shifted, directed switch is shown by matrix element 36. Since external exceptions EA are prioritized in principle with respect to internal exceptions IA, the following operation chain S.D_{I}→.D_{E} is executed. That is to say that a switching is made to the first context D_{I} by means of the first operation S.D_{I}, the context parameter set of the second context D_{E} being prepared in such a way that the second context D_{E} is set as the one calling the first context D_{I} (D_{I}→S.D_{E}), so that a switching is made directly to the second D_{E} in the event of a blocking of the first context D_{I}.

X←V.y: Concatenated, Directed Switch from the First Context X to the Second Context y:

The next return switch R of the first context X is replaced by the following operation X→S.D_{C}V.y.

The difference between the concatenated, directed switch X←V.y and the shifted, directed switch X→V.y results from the fact that in the former it is not permitted to reprogram the context parameter set of the second context y before the return switch R for the first context X is executed. Consequently, the first return switch R of the first context X is replaced by the following operation X→S.Dcv.y.

X→S.y: Shifted Switch from the First Context X to the Second Context y:

The next return switch R of the first context X is replaced by the operation X→S.D_{c}S.y. This operation is equivalent to setting the second context y as the one calling the first context X, so that when the next return switch R of the context X occurs, a “switch back” is made to the calling entity, the second context y.

C(X)=y (the second context y is set as the one calling the first context X)

X←N: Concatenated Nullification

The next return switch R of the first context X is replaced by the normal operation N. This has the effect of changing over the first context X to a second context y whose shifted switch R was the first context X itself. The result is that no switch at all is executed. Consequently, the first occurring return switch R of the context X is replaced by a normal operation N.

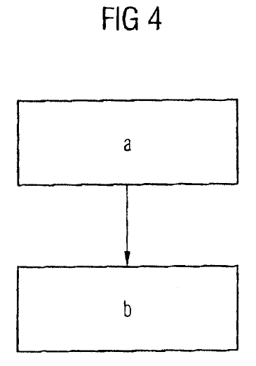

FIG. 4 shows a schematic flow diagram of a preferred exemplary embodiment of the method according to the invention for operating a multithread processor 1 with a context changeover without overhead for the data processing of the threads, a dedicated context D_{C}, D_{I}, D_{E} being provided for each thread within the multithread processor 1. The method according to the invention has the following method steps:

Method Step a):

Receiving an internal exception IA for switching from a current context D_{C} to a destination context D_{I} of the internal exception IA and/or an external exception EA for changing over from the current context D_{C} to a destination context D_{E} of the external exception EA.

Method Step b):

Updating a context parameter set KPS(D_{C}) of the current context D_{C} and/or a context parameter set KPS(D_{E}) of a destination context D_{E} of the internal exception IA and/or a context parameter set KPS(D_{I}, D_{E}) of the external exception EA and setting a switch parameter set UPS for a sequence control 7 of the program instructions PB to be fetched in such a way that the multithread processor 1 switches without restrictions and/or cycle loss or overhead between the current context D_{C} and the destination context D_{I} of the internal exception IA and/or the destination context D_{I} of the external exception EA.

Although the present invention has been described above on the basis of preferred exemplary embodiments, it is not restricted thereto, but rather can be modified in diverse ways.

In this case, it should be noted in particular that the same principle or the same method can also be employed for the case where the internal exception is caused by a context which does not correspond to the current context D_{C}. If the internal exception IA from the non-current context D_{C} and the external exception EA have the same destination context, that can be resolved by means of a switch table in accordance with FIG. 3. If the internal exception IA and the external exception EA have different destination contexts, a switch will be made to the destination context D_{E} of the external exception EA, while the destination context D_{I} of the internal exception IA is updated as described above, but does not become active (that is to say a switch is not made to it).

Depending on the construction of the processor, it is also possible for a plurality of conflicts or exceptions to occur simultaneously. By way of example, one might wish to permit a plurality of internal exceptions from different non-current contexts within the pipeline of the processor and to resolve the conflicts which occur as a result. According to the invention, such conflicts are resolved by means of such a changeover table in accordance with FIG. 3.

Although modifications and changes may be suggested by those skilled in the art, it is the intention of the inventor to embody within the patent warranted heron all changes and modifications as reasonably and properly come within the scope of his contribution to the art.

I claim as my invention:

1. A multithread processor for the data processing of a plurality of threads, each being provided with a dedicated context; said multithread processor comprising a switching table, which
receives at least one of an internal exception of a specific context for updating said specific context and for switching from said specific context to a target context of said internal exception or an external exception of a specific context for updating said specific context and for switching from said specific context to a target context of said external exception,
and, in a manner dependent thereon,
updates at least one of a context parameter set of said context, a context parameter set of said target context of said internal exception, or a context parameter set of said target context of said external exception, and
sets a switch parameter set for a sequence control of program instructions to be fetched, so that said multithread processor switches between said context and said target context of at least one of said internal or said external exception without restrictions or cycle loss.

2. The multithread processor of claim 1, comprising an instruction fetch pipeline stage for fetching said program instructions from a program instruction memory and an instruction decoding pipeline stage; said switching table being arranged within said instruction decoding pipeline stage.

3. The multithread processor of claim 1, wherein said switch parameter set is formed from at least one of:
a context flag specifying the current context of said corresponding pipeline stage;
a program instruction address of the next program instruction of said current context of said corresponding pipeline stage,
a squash reset flag specifying processing again subsequent program instructions of said current context of said corresponding pipeline stage;
a kill flag indicating not to take into account jump instructions of a subsequent pipeline stage, which are situated in said current context of said switching table.

4. The multithread processor of claim 1, wherein each of said context parameter sets is formed from at least one of:
a program address of said corresponding context;
a program address of a delay slot instruction of said corresponding context;
a squash flag of the corresponding of said contexts, said squash flag specifying not to process program instructions of said corresponding context;
a flag for specifying a pending program address of said corresponding context;
a flag for specifying a pending delay slot instruction of said corresponding context;
a flag for specifying a number of pending delay slot instructions of said corresponding context.

5. The multithread processor of claim 1, wherein said switching table, upon receiving said internal exception and said external exception, updates said context parameter set of a current of said context, said context parameter set of said target context of said internal exception and said context parameter set of said target context of said external exception in such a way so that said multithread processor switches from said current context to said target context of said external exception, upon occurrence of a blocking of said target context of said external exception to said target context of said internal exception and then, upon occurrence of a blocking of said target context of said internal exception, back to the original of said current context.

6. The multithread processor of claim 2, wherein said instruction decoding pipeline stage comprises a program address table, which buffer-stores a valid context parameter set in each case for each of said contexts of said multithread processor; said switching table in each case updating said stored context parameter sets of a current of said context of said target context of said internal exception and of said target context of said external exception.

7. The multithread processor of claim 2, comprising at least one further pipeline stage being arranged downstream of said instruction decoding pipeline stage and processing said decoded program instructions.

8. The multithread processor of claim 7, wherein each of said further pipeline stages, if said program instruction processed is a jump instruction, provides a further switch parameter set and a validity signal for specifying a validity of said further switch parameter set.

9. The multithread processor of claim 8, wherein said switch parameter set comprises a squash reset flag specifying processing again subsequent program instructions of said current context of said corresponding pipeline stage; said squash flag specifying not to process program instructions of said corresponding context; and
said processor comprising a sequence control, which receives said switch parameter set of said instruction decoding pipeline stage and also said further switch parameter sets and said validity signals of said further pipeline stages and, dependent thereon, generates a context parameter specifying which of said contexts is processed next, a program address of said context to be processed next, and said squash reset flag of context to be processed next and transmits them to said instruction fetch pipeline stage.

10. The multithread processor of claim 9, wherein said instruction fetch pipeline stage fetches said next program instruction from said program instruction memory in a manner dependent on said context parameter received by said sequence control and said received associated program address.

11. The multithread processor of claim 1, comprising a buffer memory providing, for each of said contexts of said multithread processor, a sub buffer memory in which at least in each case said program instructions are buffer stored.

12. The multithread processor of claim 11, wherein said program instructions being buffer-stored are delay slot instructions of the corresponding of said contexts.

13. The multithread processor of claim 11, wherein each of said context parameter sets is formed from at least of a squash flag of the corresponding of said contexts, said squash flag specifying not to process program instructions of said corresponding context and wherein said switching table addresses, by means of a memory flag, the respective of said sub buffer memories for buffer-storing said program instructions with a corresponding of said context parameters and the corresponding of said squash reset flags of said corresponding context.

14. The multithread processor of claim 2, wherein said instruction decoding pipeline stage comprises an instruction decoder for decoding said fetched program instructions.

15. The multithread processor of claim 14, comprising a buffer memory providing, for each of said contexts of said multithread processor, a sub buffer memory in which at least in each case said program instructions are buffer stored; said buffer-stored program instructions being delay slot instructions of the corresponding of said contexts.

16. The multithread processor of claim 15, wherein each of said context parameter sets is formed from at least of a squash flag of the corresponding of said contexts, said squash flag specifying not to process program instructions of said corresponding context and wherein said instruction decoder receives said context parameter, said program instruction addressed by said program address and fetched from said program instruction memory, and said squash reset flag from said buffer memory and also said flag for specifying said number of delay slot instructions of said context to be processed from said program address table, and, in a manner dependent thereon, updates said flag for specifying said number of delay slot instructions, said address of said delay slot instruction of said context to be processed and said address of said pending delay slot instruction of said context to be processed and transmits them to said program address table.

17. The multithread processor of claim 16, wherein said instruction decoder, in each clock cycle, reads out said program instruction of said current context and said associated squash reset flag from said buffer memory and sets said squash flag of said current context to a negative logic signal level if said squash reset flag read-out has a positive logic signal level.

18. The multithread processor of claim 17, wherein said instruction decoder, in each clock cycle in which said squash flag of said current context is set to said positive logic signal level, writes NOP instructions to said respective sub buffer memory for said current context of said buffer memory.

19. The multithread processor of claim 17, wherein said instruction decoder, in the case of said positive signal level of said flag for specifying said number of delay slot instructions of said current context, sets said next program address to said address of said delay slot instruction of said current context if said flag for specifying a pending delay slot instruction of said current context has said positive signal level.

20. The multithread processor of claim 17, wherein said instruction decoder in the case of said positive signal level of said flag for specifying said number of delay slot instructions of said current context and said negative signal level of said flag for specifying a pending program address of said current context, sets said next program address to said program address of said current context if said flag for specifying a pending program address has said positive signal level.

21. The multithread processor of claim 17, wherein said instruction decoder, in the case of said positive signal level of said flag for specifying the number of delay slot instructions of said current context, said negative signal level of said flag for specifying a pending program address of said current context and said negative signal level of said flag for specifying a pending program address of said current context, sets said next program address to said program address of said current context incremented by one.

22. The multithread processor of claim 9, wherein said sequence control receives said switch parameter set of said instruction decoding pipeline stage and also said further switch parameter sets and said validity signals of said further pipeline stages and, in a manner dependent thereon, in each case determines a lowest pipeline stage of said pipeline for each of said contexts of said multithread processor which processes said jump instruction of the respective of said contexts.

23. The multithread processor of claim 22, wherein said sequence control, in a manner dependent on said determined lowest pipeline stage of said current context flag, determines said context parameter of said next context to be processed, said program address of said next context to be processed and said squash reset flag of said next context to be processed.

24. The multithread processor of claim 9, wherein said sequence control, for each of said contexts of said multithread processor which does not correspond to said current context flag, in each case updates said corresponding context parameter set and writes said updated context parameter sets to said program address table.

25. The multithread processor of claim 6, comprising a a selection device receiving said context parameter set of said current context, said context parameter set of said target context of said internal exception and said context parameter set of said target context of said external exception from said switching table, said context parameter set of said current context from said program address table and said next program address from said instruction decoder and, in a manner dependent thereon, generates said next program instruction address and the associated of said squash reset flag of said current context and transmits them to said sequence control.

26. The multithread processor of claim 2, wherein each of said pipeline stages which is arranged downstream of said instruction decoding pipeline stage provides an internal exception upon occurrence of an interrupt.

27. A method for operating a multithread processor for the data processing of threads, each comprising a dedicated context within said multithread processor; said method comprising the steps of:
receiving at least one of an internal exception of a specific context for updating said context and switching from said context to a target context of said internal exception, or an external exception of a specific context for updating said context and switching from said context to a target context of said external exception;
updating at least one of a context parameter set of said context, a context parameter set of said target context of said internal exception, or a context parameter set of said target context of said external exception; and
setting a switch parameter set for a sequence control of program instructions to be fetched, so that said multithread processor switches between said context and said target context of at least one of said internal or said external exception without restrictions or cycle loss.
